(19) United States
(12) Patent Application Publication
(10) Pub. No.: US 2011/0235938 A1
(43) Pub. Date: Sep. 29, 2011

(54) Method and Device for Adaptively Removing Noise from an Image

(76) Inventor: Yu-Mao Lin, Tainan City (TW)

(21) Appl. No.: 13/053,214

(22) Filed: Mar. 22, 2011

(30) Foreign Application Priority Data
Mar. 29, 2010 (TW) 099109358

(51) Int. Cl. G06K 9/40

(52) U.S. Cl. 382/264

(57) ABSTRACT

An image processing method for adaptively removing noise from an image is disclosed. The image processing method includes computing a plurality of gradients for one of a plurality of pixels of the image, determining an edge level and an edge direction of the pixel according to the plurality of gradients, selecting a plurality of nearby pixels from the plurality of pixels according to the edge level and the edge direction, computing a plurality of likelihoods between the pixel and the plurality of nearby pixels, generating a plurality of weights according to the plurality of likelihoods, and applying weighted low-pass filtering to the plurality of nearby pixels and the pixel according to the plurality of weights to generate an output pixel.

### BACKGROUND OF THE INVENTION

1. Field of the Invention

The present invention is related to an image processing method and device, and more particularly, to an image processing method and device which adaptively remove noise from an image through detecting edge directions of the image.

2. Description of the Prior Art

With popularity of digital recording and broadcasting equipment, industry and consumers require more and more digital processing techniques to edit recorded digital data or enhance broadcasted digital program quality. For example, an image sharpening technique is frequently applied to monitors to enhance frame resolution.

In general, high frequency components of an image signal include information of edge and texture details. For that reason, a primary concept of image sharpening is to enhance the high frequency components, so as to enhance the frame resolution. More specifically, the image sharpening technique first acquires the high frequency components, and then adds the high frequency components to the image. However, acquisition and transmission of the image signal come along with noise, characterized by a wide distributed spectrum, i.e. including both high and low frequency noise. Therefore, before the high frequency component acquisition, a noise removal process has to be performed on the image signal; otherwise the high frequency noise components are amplified and added to the image, causing a decline in image quality.

In practice, the noise removal process is implemented by sending the image signal to a low-pass filter to filter out the high frequency noise from the image signal. However, the high frequency components of the image are removed or decayed during the noise removal process as well, which blurs the edge and texture details of the image. That is, the conventional low-pass filter cannot distinguish between the high frequency components and the high frequency noise, such that the image suffers from loss of information detail when the image sharpening technique is applied.

Therefore, removing noise from the image without sacrificing the high frequency components has been a major focus of the industry.

### SUMMARY OF THE INVENTION

It is therefore a primary objective of the claimed invention to provide an image processing method and device.

The present invention discloses an image processing method for adaptively removing noise from an image. The image processing method comprises computing a plurality of gradients corresponding to a plurality of directions for one of a plurality of pixels of the image, determining an edge level and an edge direction of the pixel according to the plurality of gradients, selecting a plurality of nearby pixels around the pixel from the plurality of pixels according to the edge level and the edge direction, computing a plurality of likelihoods between the pixel and the plurality of nearby pixels, generating a plurality of weights according to the plurality of likelihoods, and applying weighted low-pass filtering to the plurality of nearby pixels and the pixel according to the plurality of weights to generate an output pixel.

The present invention further discloses an image processing device for adaptively removing noise from an image. The image processing device comprises a reception end for receiving a plurality of pixels of the image, an output end for outputting an output pixel, an edge detector comprising at least one gradient detector for computing a plurality of gradients corresponding to a plurality of directions for one of the plurality of pixels, and a gradient analyzer for determining an edge level and an edge direction of the pixel according to the plurality of gradients, a pixel delay unit for delaying the plurality of pixels to be synchronized with the edge level and the edge direction, a pixel selector for selecting a plurality of nearby pixels around the pixel from the plurality of pixels according to the edge level and the edge direction, and an adaptive low-pass filtering device comprising a likelihood computing unit for computing a plurality of likelihoods between the pixel and the plurality of nearby pixels, a weight generator for generating a plurality of weights according to the plurality of likelihoods, and a low-pass filter for applying weighted low-pass filtering to the plurality of nearby pixels and the pixel according to the plurality of weights to generate the output pixel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an image processing device according to an embodiment of the present invention.

FIG. 1B is a schematic diagram of an edge detector of the image processing device shown in FIG. 1A.

FIG. 1C is a schematic diagram of an adaptive low-pass filtering device of the image processing device shown in FIG. 1A.

FIG. 2A to FIG. 2C are schematic diagrams of embodiments of how a pixel selector shown in FIG. 1A selects nearby pixels.

FIG. 3 is a schematic diagram of an image processing process according to an embodiment of the present invention.

### DETAILED DESCRIPTION

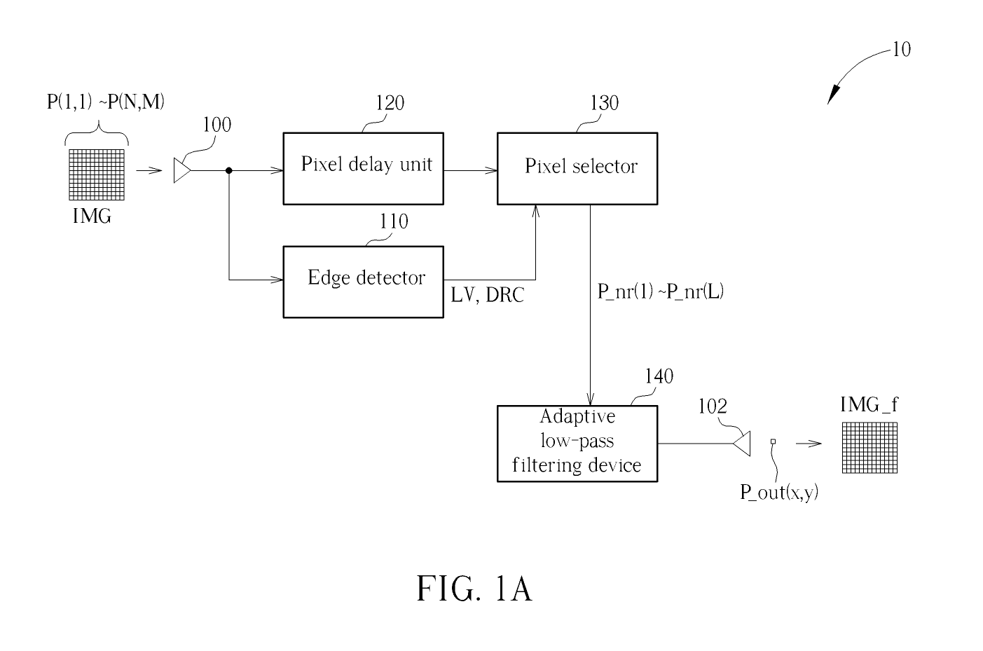

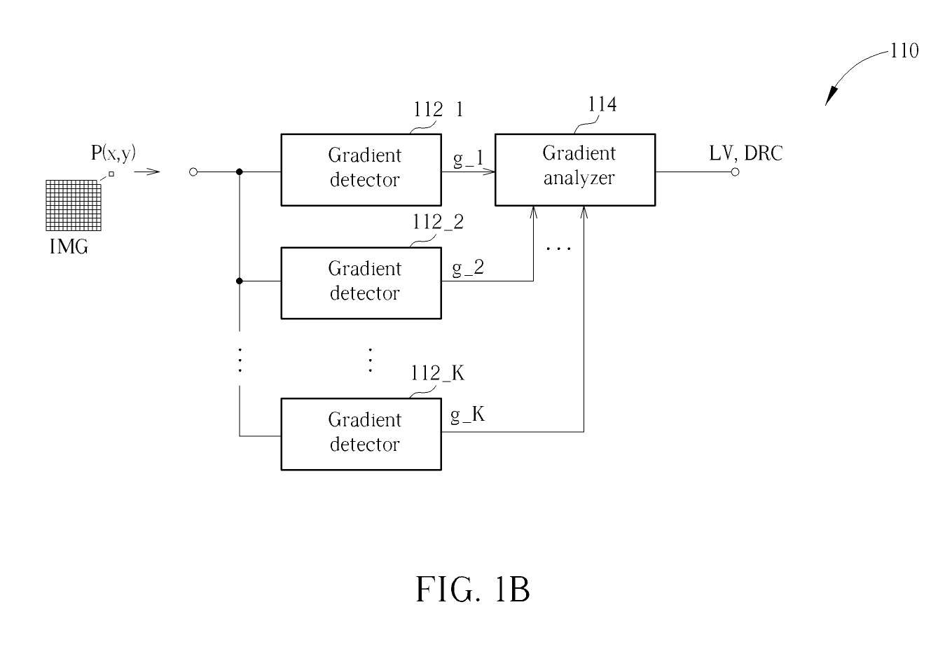

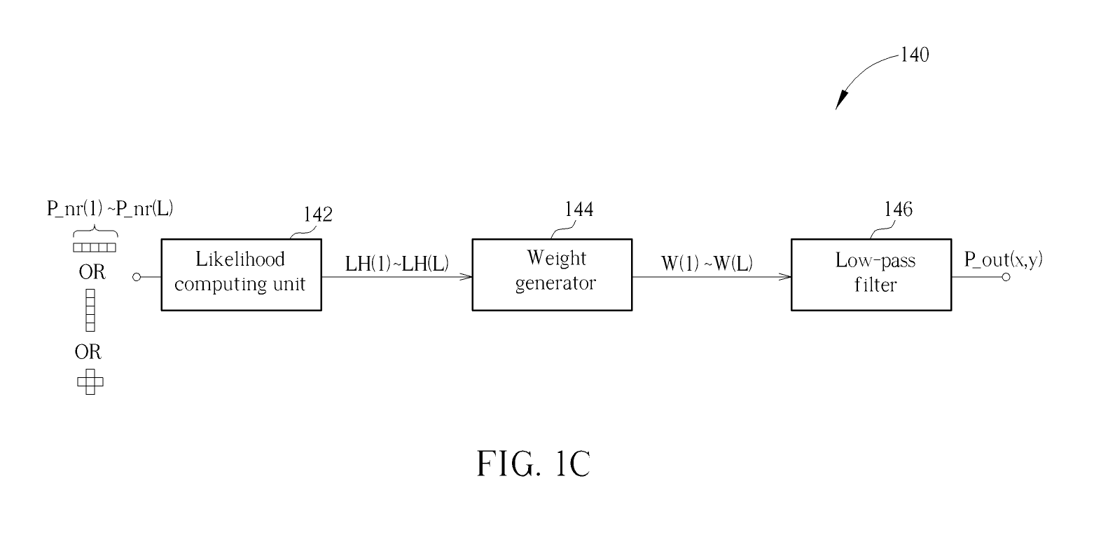

Please refer to FIG. 1A, which is a schematic diagram of an image processing device 10 according to an embodiment of the present invention. The image processing device 10 is utilized for adaptively removing noise from an image IMG, and includes a reception end 100, an output end 102, an edge detector 110, a pixel delay unit 120, a pixel selector 130 and an adaptive low-pass filtering device 140. The reception end 100 is utilized for receiving pixels P(1,1)-P(N,M) of the image IMG. The output end 102 is utilized for outputting an output pixel P_out(x,y) corresponding to an image-sharpened pixel P(x,y) of the pixels P(1,1)-P(N,M). The edge detector 110 includes gradient detectors 112_1-112_K (K≧1) and a gradient analyzer 114, as illustrated in FIG. 1B. The gradient detectors 112_1-112_K are utilized for computing gradients g_1-g_K corresponding to K directions for the pixel P(x,y). The gradient analyzer 114 is utilized for determining an edge level LV and an edge direction DRC of the pixel P(x,y) according to the gradients g_1-g_K. The pixel delay unit 130 is utilized for delaying the pixels P(1,1)-P(N,M) to be synchronized with the edge level LV and the edge direction DRC. The pixel selector 130 is utilized for selecting nearby pixels P_nr(1)-P_nr(L) around the pixel P(x,y) from the pixels P(1,1)-P(N,M) according to the edge level LV and the edge direction DRC. The adaptive low-pass filtering device 140 includes a likelihood computing unit 142, a weight generator 144 and a low-pass filter 146, as illustrated in FIG. 1C. The likelihood computing unit 142 is utilized for computing likelihoods LH(1)-LH(L) between the pixel P(x,y) and the nearby pixels P_nr(1)-P_nr(L). The weight generator 144 is utilized for generating weights W(1)-W(L) according to the likelihoods LH(1)-LH (L). Finally, the low-pass filter 146 applies weighted low-pass filtering to the nearby pixels P_nr(1)-P_nr(L) and the pixel P(x,y) according to the weights W(1)-W(L) to generate the output pixel P_out(x,y).

In short, to overcome the disadvantage that the high frequency components are removed along with noise during the noise removal process of the prior art, the edge detector 110 calculates the gradients g_1-g_K corresponding to the K directions for each pixel of the image IMG to determine the edge level LV and the edge direction DRC of each pixel. Next, the pixel selector 130 “directionally” selects the nearby pixels P_nr(1)-P_nr(L) to avoid filtering out the high frequency components in a weighted low-pass filtering step of the noise removal process. In other words, based on facts that the high frequency components, such as edge and texture patterns, are directional, but the high frequency noise is not, the edge direction DRC is taken into computation during the noise removal process to distinguish the high frequency noise and the high frequency components.

Note that, the edge direction DRC can be any direction parallel to a plane of the image IMG. However, with limited data throughput, practical circuits may not be able to afford such a large number of computation tasks. That is, computing gradients of the pixel P(x,y) for all directions is costly. To simplify computation complexity, preferably, the edge detector 110 merely calculates gradients g_1, g_2 of the pixel P(x,y) along two orthogonal directions, such as a vertical direction and a horizontal direction to simulate an actual edge direction. Certainly, those skilled in the art can increase a number of calculated gradients of the pixel P(x,y) to reduce difference between the simulated and actual edge directions, so as to enhance efficiency of conserving the high frequency components.

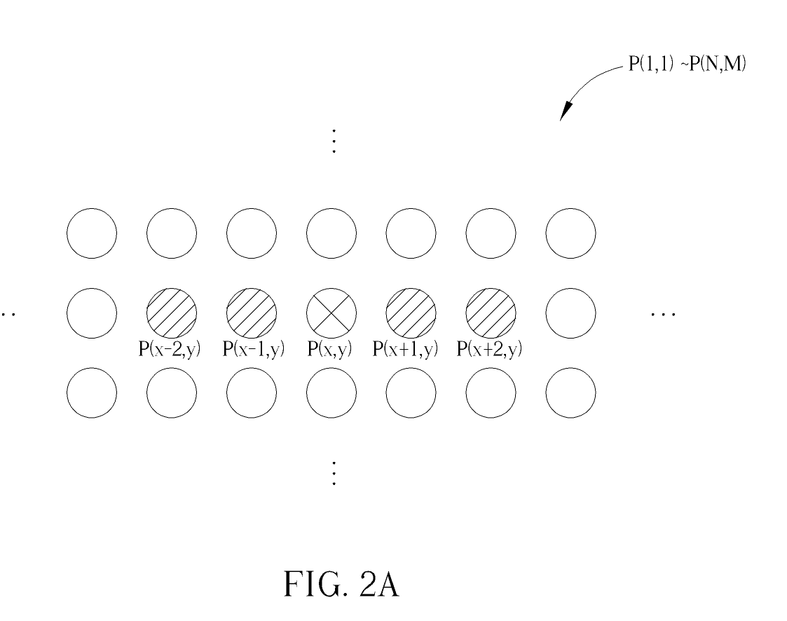

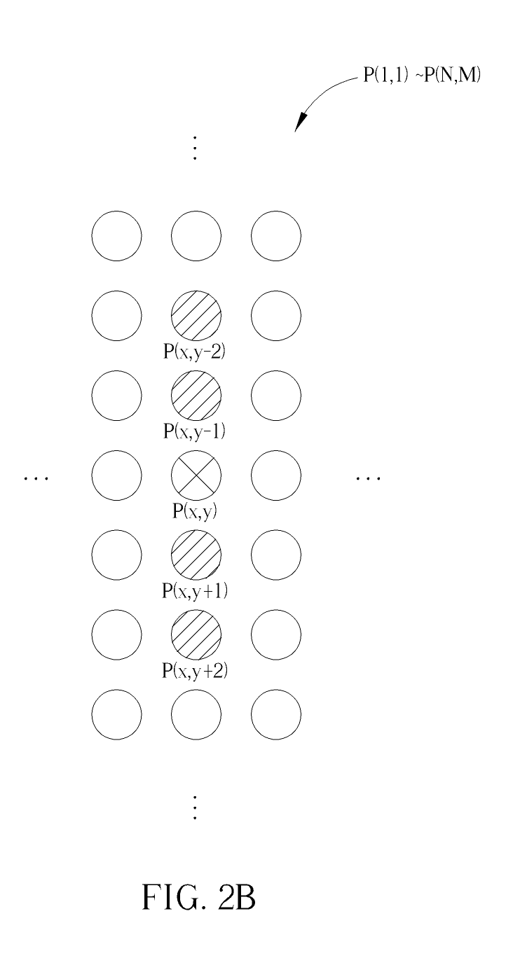

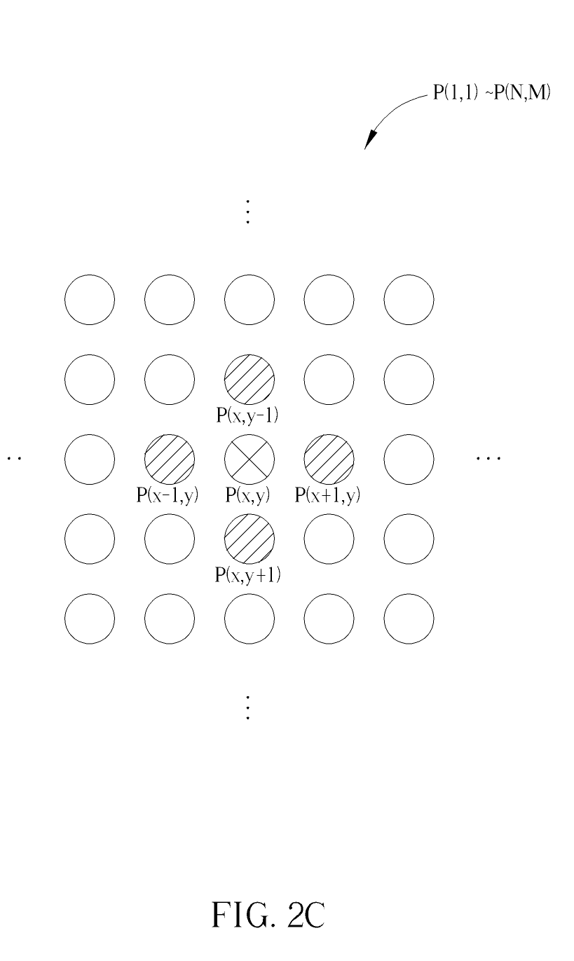

For example, please refer to FIG. 2A, FIG. 2B and FIG. 2C, which are schematic diagrams of embodiments of how the pixel selector 130 selects the nearby pixels P_nr(1)-P_nr(L) along the vertical direction and the horizontal direction. If an absolute value of the horizontal gradient is greater than an absolute value of the vertical gradient, the gradient analyzer 114 determines the horizontal direction to be the edge direction DRC. Next, the pixel selector 130 selects pixels P(x−2,y), P(x−1,y), P(x+1,y), P(x+2,y) horizontally nearby the pixel P(x,y) to be the nearby pixels P_nr(1)-P_nr(L), as illustrated in FIG. 2A. Inversely, if the absolute value of the horizontal gradient is less than the absolute value of the vertical gradient, the gradient analyzer 114 determines the vertical direction to be the edge direction DRC, and the pixel selector 130 selects pixels P(x,y−2), P(x,y−1), P(x,y+1), P(x,y+2) vertically nearby the pixel P(x,y) to be the nearby pixels P_nr(1)-P_nr(L), as illustrated in FIG. 2B.

Certainly, the pixel P(x,y) may not belong to any edge pattern, i.e. both the horizontal gradient and the vertical gradient indicate the edge level LV is insignificant. In such a situation, the pixel selector 130 averagely selects pixels P(x−1,y), P(x+1,y), P(x,y−1), P(x,y+1) around the pixel P(x,y) to be the nearby pixels P_nr(1)-P_nr(L), as illustrated in FIG. 2C.

Note that, FIG. 2A, FIG. 2B and FIG. 2C are merely utilized for illustrating how the present invention implements “directional” low-pass filtering. Those skilled in the art can accordingly adjust a selected pixel scope, direction, etc. to meet different requirements.

Once the nearby pixels P_nr(1)-P_nr(L) are selected, the likelihood computing unit 142 computes absolute values of reciprocals of differences between the nearby pixels P_nr(1)-P_nr(L) and the pixel P(x,y) to be the likelihoods LH(1)-LH(L). Take FIG. 2A for example, likelihoods between the pixel P(x,y) and the nearby pixels P(x−2,y), P(x−1,y), P(x+1,y), P(x+2,y) are

$$\frac{1}{\vert P ( x , y ) - P ( x - 2 , y ) \vert} , \frac{1}{\vert P ( x , y ) - P ( x - 1 , y ) \vert} , \\ \frac{1}{\vert P ( x , y ) - P ( x + 1 , y ) \vert} , \frac{1}{\vert P ( x , y ) - P ( x + 2 , y ) \vert}$$

respectively.

Finally, the weight generator 144 generates the weights W(1)-W(L) of the nearby pixels P_nr(1)-P_nr(L) against the pixel P(x,y) one-to-one according to the likelihoods LH(1)-LH(L). In theory, the greater the likelihood, the smaller the chance the high frequency noise exists among the nearby pixels P_nr(1)-P_nr(L) and the pixel P(x,y). For that reason, when a weight corresponds to a high one of the likelihoods LH(1)-LH(L), the weight generator 144 preferably maintains the weight to be a standard weight, such as 1. On the contrary, when a weight corresponds to a low one of the likelihoods LH(1)-LH(L), implying the high frequency noise probably exists among the nearby pixels P_nr(1)-P_nr(L) and the pixel P(x,y), the weight generator 144 reduces the weight to filter out the high frequency noise.

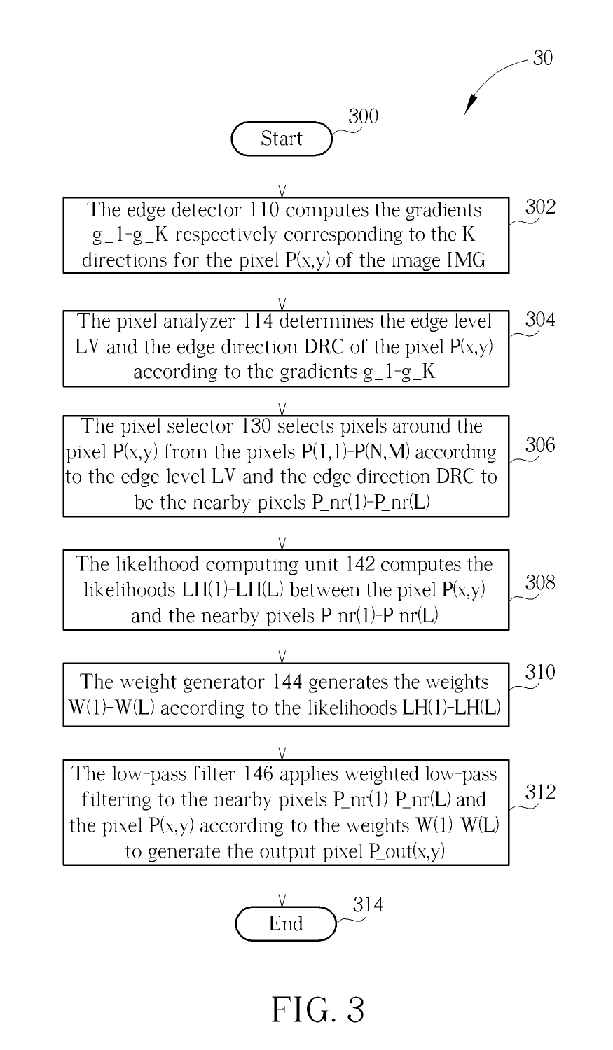

Operations of the image processing device 10 can be summarized into an image processing process 30, as illustrated in FIG. 3. The image processing process 30 includes the following steps:

Step 300: Start.

Step 302: The edge detector 110 computes the gradients g_1-g_K respectively corresponding to the K directions for the pixel P(x,y) of the image IMG.

Step 304: The pixel analyzer 114 determines the edge level LV and the edge direction DRC of the pixel P(x,y) according to the gradients g_1-g_K.

Step 306: The pixel selector 130 selects pixels around the pixel P(x,y) from the pixels P(1,1)-P(N,M) according to the edge level LV and the edge direction DRC to be the nearby pixels P_nr(1)-P_nr(L).

Step 308: The likelihood computing unit 142 computes the likelihoods LH(1)-LH(L) between the pixel P(x,y) and the nearby pixels P_nr(1)-P_nr(L).

Step 310: The weight generator 144 generates the weights W(1)-W(L) according to the likelihoods LH(1)-LH(L).

Step 312: The low-pass filter 146 applies weighted low-pass filtering to the nearby pixels P_nr(1)-P_nr(L) and the pixel P(x,y) according to the weights W(1)-W(L) to generate the output pixel P_out(x,y).

Step 314: End.

Details of the image processing process 30 can be referred from the description of the image processing device 10, and are not further narrated herein.

In the prior art, the high frequency components of the image, such as edge and texture patterns, are removed with the noise during the noise removal process of the image sharpening process. In other words, the image is sharpened, but suffers from a side effect of high frequency component loss, causing blurred patterns in the image. In comparison, based on the facts that edge and texture patterns are directional, and the noise is not, the present invention utilizes the edge detector 110 to detect the edge direction DRC, such that the edge direction DRC can be taken into computation when the adaptive low-pass filtering device 140 performs the low-pass noise removal operation. As a result, monitors can directly filter out the high frequency noise without losing the high frequency components.

To sum up, the present invention adaptively applies different noise removal computation methods based on image contents to conserve the high frequency components of the image during the noise removal process.

Those skilled in the art will readily observe that numerous modifications and alterations of the device and method may be made while retaining the teachings of the invention.

What is claimed is:

1. An image processing method for adaptively removing noise from an image, the image processing method comprising:
computing a plurality of gradients corresponding to a plurality of directions for one of a plurality of pixels of the image;
determining an edge level and an edge direction of the pixel according to the plurality of gradients;
selecting a plurality of nearby pixels around the pixel from the plurality of pixels according to the edge level and the edge direction;
computing a plurality of likelihoods between the pixel and the plurality of nearby pixels;
generating a plurality of weights according to the plurality of likelihoods; and
applying weighted low-pass filtering to the plurality of nearby pixels and the pixel according to the plurality of weights to generate an output pixel.

2. The image processing method of claim 1, wherein the plurality of directions comprises a first direction and a second direction orthogonal to each other.

3. The image processing method of claim 1, wherein the step of selecting the plurality of nearby pixels around the pixel from the plurality of pixels according to the edge level and the edge direction comprises selecting parts of the plurality of pixels horizontally nearby the pixel to be the plurality of nearby pixels when the edge direction is a horizontal direction.

4. The image processing method of claim 1, wherein the step of selecting the plurality of nearby pixels around the pixel from the plurality of pixels according to the edge level and the edge direction comprises selecting parts of the plurality of pixels vertically nearby the pixel to be the plurality of nearby pixels when the edge direction is a vertical direction.

5. The image processing method of claim 1, wherein the step of selecting the plurality of nearby pixels around the pixel from the plurality of pixels according to the edge level and the edge direction comprises averagely selecting parts of the plurality of pixels around the pixel to be the plurality of nearby pixels when the edge direction is insignificant.

6. The image processing method of claim 1, wherein the step of computing the plurality of likelihoods between the pixel and the plurality of nearby pixels comprises computing a plurality of absolute values of a plurality of reciprocals of a plurality of grey-level differences between the plurality of nearby pixels and the pixel to be the plurality of likelihoods.

7. The image processing method of claim 1, wherein the step of generating the plurality of weights according to the plurality of likelihoods comprises maintaining the weight to be a standard weight when the weight corresponds to a high likelihood of the plurality of likelihoods.

8. The image processing method of claim 1, wherein the step of generating the plurality of weights according to the plurality of likelihoods comprises reducing the weight when the weight corresponds to a low likelihood of the plurality of likelihoods.

9. An image processing device for adaptively removing noise from an image, the image processing device comprising:
a reception end, for receiving a plurality of pixels of the image;
an output end, for outputting an output pixel;
an edge detector, comprising:
at least one gradient detector, for computing a plurality of gradients corresponding to a plurality of directions for one of the plurality of pixels; and
a gradient analyzer, for determining an edge level and an edge direction of the pixel according to the plurality of gradients;
a pixel delay unit, for delaying the plurality of pixels to be synchronized with the edge level and the edge direction;
a pixel selector, for selecting a plurality of nearby pixels around the pixel from the plurality of pixels according to the edge level and the edge direction; and
an adaptive low-pass filtering device, comprising:
a likelihood computing unit, for computing a plurality of likelihoods between the pixel and the plurality of nearby pixels;
a weight generator, for generating a plurality of weights according to the plurality of likelihoods; and
a low-pass filter, for applying weighted low-pass filtering to the plurality of nearby pixels and the pixel according to the plurality of weights to generate the output pixel.

10. The image processing device of claim 9, wherein the plurality of directions comprises a first direction and a second direction orthogonal to each other.

11. The image processing device of claim 9, wherein the pixel selector selects parts of the plurality of pixels horizontally nearby the pixel to be the plurality of nearby pixels when the edge direction is a horizontal direction.

12. The image processing device of claim 9, wherein the pixel selector selects parts of the plurality of pixels vertically nearby the pixel to be the plurality of nearby pixels when the edge direction is a vertical direction.

13. The image processing device of claim 9, wherein the pixel selector averagely selects parts of the plurality of pixels around the pixel to be the plurality of nearby pixels when the edge direction is insignificant.

14. The image processing device of claim 9, wherein the likelihood computing unit computes a plurality of absolute values of a plurality of reciprocals of a plurality of grey-level differences between the plurality of nearby pixels and the pixel to be the plurality of likelihoods.

15. The image processing device of claim 9, wherein the weight generator maintains the weight to be a standard weight when the weight corresponds to a high likelihood of the plurality of likelihoods.

16. The image processing device of claim 9, wherein the weight generator reduces the weight when the weight corresponds to a low likelihood of the plurality of likelihoods.
